(19) United States
(12) Patent Application Publication
(10) Pub. No.: US 2009/0313571 A1
(43) Pub. Date: Dec. 17, 2009

(54) METHOD FOR CUSTOMIZING DATA ENTRY FOR INDIVIDUAL TEXT FIELDS

(76) Inventor: Samuel Jacob HORODEZKY, San Diego, CA (US)

Correspondence Address: QUALCOMM INCORPORATED, 5775 MOREHOUSE DR., SAN DIEGO, CA, 92121, US

(21) Appl. No.: 12/139,765

(22) Filed: Jun. 16, 2008

(51) Int. Cl. G06F 3/048

(52) U.S. Cl. 715/780

(57) ABSTRACT

Methods and devices enable customizing the manner in which data is entered for individual text fields of individual applications executing on a mobile device. Embodiments enable users to specify the language or the data entry method of the text entered in individual text fields which may vary from one text field to another. Alternative embodiments enable users to further customize the data entry method of individual text fields to control the text case of entered characters.

### FIELD OF THE INVENTION

The present invention relates generally to electronic devices, and more particularly to customizing the data entry method of individual text fields used in applications on a mobile device.

### BACKGROUND

Usage of wireless mobile communication devices (mobile devices), such as cellular telephones, is ever increasing due to their portability and connectivity. Mobile devices are also growing in sophistication, supporting many useful applications that can run simultaneously, becoming multipurpose productivity tools. The applications running on mobile devices are become increasingly sophisticated. Despite the increasing sophistication of applications, the size and space constraints of most mobile devices limits the user interface to a numeric keypad with only 12 individual keys which includes digits 0-9 as well as a “*” and “#” key. In order to support alphabetic character entry, the numeric keypad also includes a number of alphabetic characters mapped to each individual numeric key.

To enable entry of text information, conventional mobile devices employ a multi-tap data entry method, which requires a user to access the alphabetic characters through a series of depression of a single numeric key. While effective, the multi-tap data entry method can be time consuming and tedious. Other data entry methods have been developed to overcome the tediousness of the multi-tap data entry method. However, these other data entry methods have various drawbacks of their own. For example, predictive text allows words to be entered by a single keypress for each letter, as opposed to a series of multiple keypress approach used in a traditional multi-tap method. In a predictive text method, as the user presses a numeric key mapped to alphabetic characters, an algorithm searches the dictionary for a list of possible words that match the keypress combination, and offers up the most probable choice. The user can then confirm the selection and move on, or use a key to cycle through the possible combinations. While the conventional multi-tap data entry method is slow and tedious, predictive text methods may have difficulty predicting proper nouns such as a person's name. In addition, for shorter words, conventional multi-tap methods may be quicker and more efficient than predictive text. Different methods of data entry may be more efficient than others in certain situations.

### SUMMARY

Various embodiment systems and methods are disclosed which allow users to customize the data entry method of individual text fields of individual applications executed on their mobile devices. Additional embodiments allow users to customize the data entry of individual text fields further by setting the text case of each individual text field of individual applications executed on their mobile devices. Other embodiments allow users to further customize the data entry of individual text fields by setting other parameters such as font size, font type, etc. Other embodiments allow users to further customize the data entry to accommodate other languages and various forms of writing and character sets.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain features of the invention.

FIG. 1 illustrates a conventional mobile device with an alphanumeric keypad.

FIG. 2 illustrates a conventional alphanumeric keypad.

FIG. 3 is a software hardware architecture of a mobile device.

FIG. 4 is a process flow diagram illustrating steps of an embodiment method.

FIG. 5 is a process flow diagram illustrating steps of an alternative embodiment.

FIG. 6 illustrates a conventional numeric keypad with imprinted marking used with a CKC Chinese Input System.

FIGS. 7a and 7b illustrate exemplary CKC Chinese Input system stroke coding of Chinese hanzi characters.

FIG. 8 is a process flow diagram illustrating steps of an embodiment.

FIGS. 9A and 9B are process flow diagrams illustrating steps of alternative embodiments.

FIG. 10a is an example of a default customizable key settings table.

FIG. 10b is an example of a customized key settings table.

FIG. 11 is a system block diagram of a mobile device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the terms “mobile device”, “mobile handset”, “handset” and “handheld device” refer to any one or all of cellular telephones, personal digital assistants (PDAs) with wireless modems, wireless electronic mail receivers (e.g., the Blackberry® and Treo® devices), multimedia Internet enabled cellular telephones (e.g., the iPhone®), wireless telephone receivers and similar personal electronic devices. In a preferred embodiment, the mobile device is a cellular handset device (e.g., a cellphone). However, cellular telephone communication capability is not necessary as the various embodiments may be implemented on a computing device which implements a variety of text data entry methods. Preferably, the mobile device has a limited user interface which may require a variety of data entry methods to efficiently enter data into text fields depending on the individual text field.

Technological developments have greatly expanded the variety of applications capable of executing on mobile device processors. Due to their relative small size and portability, the level of sophistication and power of the various applications capable of running on mobile devices are often hampered by the rudimentary user interface. Many times the limited number of hard keys allotted to a mobile device's keypad does not adequately allow the user to fully utilize the available features of an application.

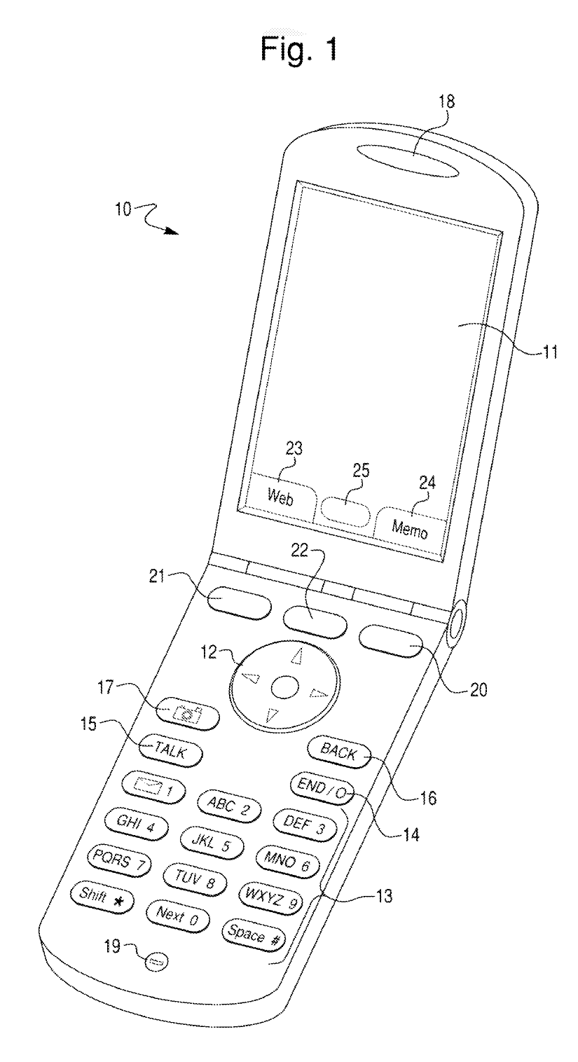

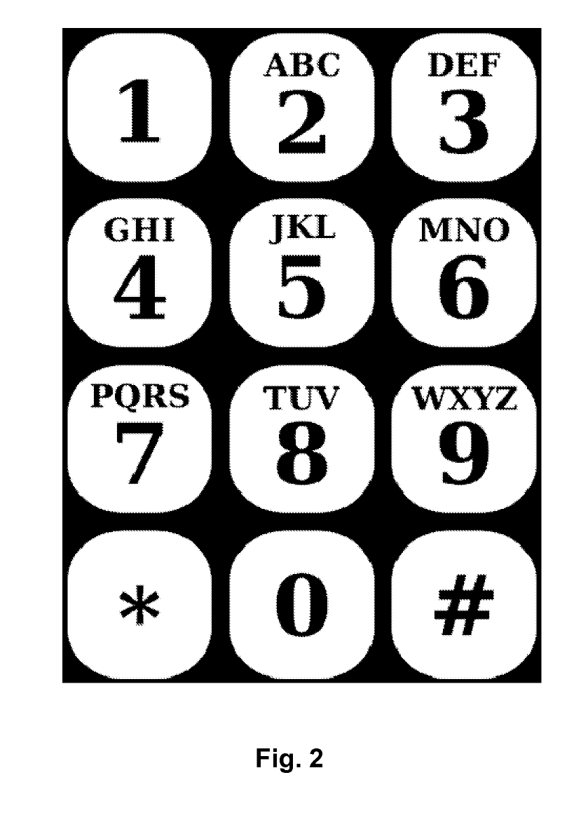

FIG. 1 illustrates a conventional mobile device. As shown in FIG. 1, a mobile device 10 (in the illustrated case, a cellular telephone handset) includes a speaker 18 and a microphone 19 for facilitating voice conversations. In addition, the mobile device 10 includes a user interface display 11 and a user interface input system which may include an alphanumeric keypad 13 as well as a number of hard keys 14-17, directional menu key 12, and a number of programmable soft keys 20-22 whose function may vary and is displayed on the user interface display through soft key labels 23-25. Typically for such mobile devices, text entered in an application by a user is done through the alphanumeric keypad 13. A conventional numeric keypad 13 which includes digits 0-9 as well as a “*” and “#” key. To minimize size and complexity, many mobile device designs forego a full QWERTY style keyboard. Instead, the numeric keypad 13 of such mobile devices typically includes alphabetic characters and/or other typographic symbols or functions mapped to each numeric key. An example of a conventional alphanumeric keypad is shown in FIG. 2.

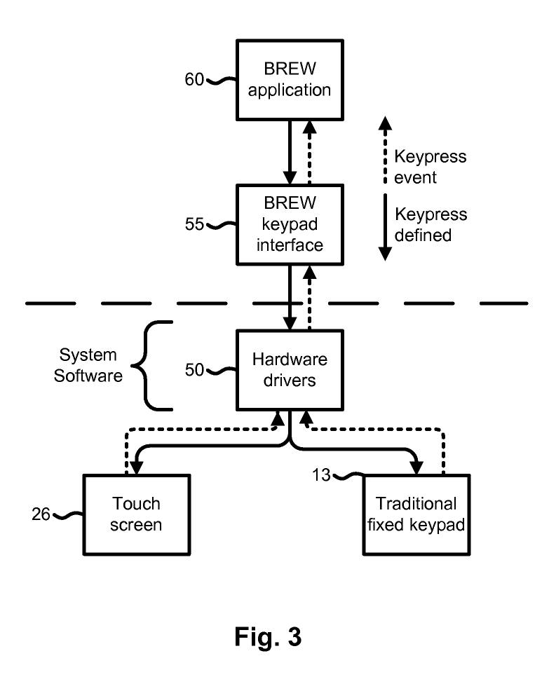

FIG. 3 illustrates a hardware software architecture of a mobile device related to relating key functions or meanings to each depression of a key on the keypad 13. Beneath the keypad 13 is a key matrix (not shown) which may be a grid of circuits configured to convert a key press into an electrical signal. When a user depresses an individual key on keypad 13, the individual key depression event may be detected in a number of ways. For example, the motion may change the capacitance of a capacitor beneath the key which can be sensed by a circuit. As another example, the motion may close a switch to enable a tiny amount of electrical current to flow (i.e., the open circuit is closed). The resulting electrical signal may then be sensed and converted into an interrupt signal by a hardware driver layer 50. The hardware driver 50 is a firmware program that converts signals from the keypad 13 into data signals which can be stored and interpreted by software applications. The hardware driver layer 50 may compare the key circuit to a key matrix to generate a coded signal representative of the depressed key. A keypad interface layer 55, which may be any of a number of interfaces known in the art, can translate the bit code output by the keypad into a code or value that can interpreted by an application. Various application development platforms may implement a keypad interface 55 specific to that platform. For example, the Binary Runtime Environment for Wireless (BREW) is an application development platform that can download and run a number of applications on mobile devices. The keypad interface 55 receives the bit codes output from the keypad driver layer 50 and output messages that are interpretable by applications running on the mobile device. The keypad interface layer may also cause the user interface display 11 to display a particular character or instruct the processor to perform some function. One of skill in the art would appreciate that similar operations may occur if the user is using a touch screen keyboard 26 to enter data as opposed to a traditional fixed keypad 13.

Different applications may interpret keypress events in different ways consistent with the functions of the application. For example, a text message entry application will interpret a key press as representing one of a number of letters, or a number or symbol that may be included in a text message. As another example, various game applications may redefine keypresses events into directional movement or game actions (e.g., “fire weapons”) so that a user can control the actions during gameplay with the conventional keypad 13. The keypad interface layer 55 may pass the keypress event to an application 60 to determine whether the keypad entries have been remapped for a specific application. The keypress event may be communicated from the keypad interface layer 55 to the application layer 60. For example, an application 60 may be configured to accept alphabetic text inputted via the keypad 13. Accordingly, the application 60 may interpret each keypress event to correspond to an alphabetic letter rather than a number.

In order to represent both alphabetic letters and numbers on a conventional twelve key telephone keypad such as illustrated in FIG. 2, a single key must be mapped to a number as well as several alphabetic letters, typographic symbols, or character components (as in CKC Chinese Input system stroke coding and other languages). For example, as shown in FIGS. 1 and 2, the number 2 key can be used to represent the letters A, B, and C as well in cellular telephones used in English speaking countries. Since the depression of a single key may be used to represent an assortment of numbers or letters, a data entry method is needed to determine if the depression of the “2” key should correspond to the number “2” or one of the letters “A,” “B,” or “C,” for example. Still further, the press of an individual key may correspond to both the upper and lower case version of letters, as well as other typographic symbols. To accommodate the large number of meanings that may need to be ascribed to an individual keypress in a telephone keypad, various data entry methods may be implemented to define each keypress or series of keypresses.

As an example, multi-tap is a data entry method which may be implemented that ascribes a meaning to each key depending upon the number of times the key is pressed within a span of time. For example, when a typical implementation of the multi-tap data entry method is active, entry of the letter “b” is accomplished by depressing the numeral “2” key three times in succession. The first depression of the numeral 2 key corresponds to the letter “a”, and the second depression within a short time corresponds to the letter “b.” A further depression corresponds to the letter “c.” To enter “2” when the multi-tap entry method is active the key must be pressed four times in quick succession. In contrast, when the telephone data entry method is active, each press of the numeral “2” key corresponds to the number 2. Thus, while using the multi-tap data entry method a user depresses or “taps” a key multiple times until the desired number, letter, or symbol is displayed. When making a series of depressions, each depression in the series must be completed within some predetermined amount of time. Otherwise, the subsequent depressions may be interpreted to be the next attempt to enter data. While the multi-tap method allows the user to access each character mapped to a particular key, the multi-tap method may be tedious, particularly for entering a long text message.

To overcome the shortcomings of the multi-tap method, alternative data entry methods have been developed for generating text using a conventional twelve key alphanumeric keypad. One example is the predictive text method which is a data entry methodology that attempts to predict the word being entered with each keypress in order to simplify entry of text messages, email, and the like. With each keypress, an algorithm searches a dictionary to identify a word or words that match the combination of keypresses, and presents on the device display the most probable choice for the keypress based upon words matching the entered key sequence. With the press of each key corresponding to a letter in a word, the number of words matching the entered key sequence decreases. Thus, most words can be predicted and presented on the display before the last letter has been entered. A user can confirm the presented word if it is and move on by entering a space, press a key associated with the next letter in the word, or press a particular key to cycle through a list of other words matching the entered key sequence. A variety of predictive text method algorithms have been developed and are marketed in a variety of competing products, including for example T9®, iTap®, and eZiText®.

To compare the multi-tap data entry method with the predictive text data entry method, consider the word “the.” When the multi-tap data entry method is active, “the” is entered by pressing the 8 (tuv) key once to select “t”, pressing the 4 (ghi) key twice to select h, and pressing the 3 (def) key twice to select “e.” In contrast, when a predictive text method is active, a single press of the 8 (tuv) key will present the letter “t” on the display as the algorithm guesses that “t” is the intended letter based on the fact that more words begin with “t” than “u” or “v”. Then with the press of the 4 (ghi) key the predictive text algorithm will present the letter “h” on the display as guesses that “t” is the intended letter based on the fact that more words begin with “th” than any of “tg”, “ti” “ug,” “uh,” “ui,” “vg,” “vh,” or “vi”. At this point the predictive text algorithm may further present the word “the” in a portion of the display for the user to confirm if correct. This prediction may be made because “the” is a commonly used word that matches the key entry sequence of 8-4. In this case, the predictive text data entry method allowed entry of “the” in two button presses, compared to the five presses required with multi-tap. The benefit of the predictive text data entry method increases with word length. However, the predictive text data entry method is not without its own disadvantages.

Most predictive text systems are based on the assumption that the desired word is in a relatively small dictionary (the memory available on most mobile devices limits the number of words that can be consider in such algorithms). Thus, proper nouns, names, abbreviations, numbers and foreign language words cannot be predicted. Also, words that differ in any way from common usage will not be predicted. For example, if the word is not spelled correctly, or typed correctly, or is slang, it will not be predicted. In such cases, some other data entry method, such as multi-tap, must be used to enter the desired word or number. Furthermore, while predictive text may work efficiently with languages such as English, it may be impractical with other languages in which a single word doesn't necessarily represent a single semantic entity. Thus, while predictive text may be efficient in some uses, the conventional multi-tap method of text entry may be superior in others.

While the limitations of predictive text data entry methods can be addressed by switching to the multi-tap data entry method, this involves an extra step which may not be intuitive to a user, or require enough extra steps to obviate the advantages of predictive text. For example, an address book entry includes text fields that may include both predictable words, such as common address words and names (“Washington”) and unpredictable words, such as individual and street names. Thus, the entry of contact information may require a user to switch back and forth between predictive text and multi-tap data entry methods. Also, a user does not know whether a particular word is included within the predictive text algorithm's dictionary until the last key has been pressed. If at that point the word is not predicted, the user must delete the entered key strokes, switch to multi-tap and re-enter the word using that method. Thus, the limitations of predictive text data entry methods can lead to increased user effort associated with switching to the multi-tap method.

In a conventional user interface, individual users are able to customize the text data entry method employed on their mobile devices 10 by selecting the text data entry method that they are most comfortable using. Once selected, that data entry method may be implemented for all applications executed on the mobile device. For example, selecting predictive text as the default data entry method will activate the predictive text data entry method for all applications and data fields.

Certain applications lend themselves to use certain data entry methods over others. The embodiments disclosed herein provide users of a mobile device 10 with the ability to customize their mobile devices so that the data entry method activated depends on the specific application being executed. Additionally, an embodiment provides users with the ability to activate particular data entry methods depending on the specific data field for which data is being entered. Still further, an embodiment provides users with the ability to customize the case (i.e., upper or lower case) applied to text entered into specific data fields. Still further, an embodiment provides users with the ability to select a character set and language to be used for text entry in specific data fields.

In an embodiment, the mobile device 10 user selects a preferred data entry parameter for each text field within an application. For example, the data entry parameter for a selected text field may be the multi-tap method versus the predictive text method for data entry. The user may also select a second and third data entry parameter for a selected text field. For example, the user may select the preferred text case or font that will be used for each text field as a second or third data entry parameter. As a further example, the user may select the character set or language to be used as a second or third data entry parameter. These selections can be stored in a settings table in memory and used to form data entry as the user enters data into individual text fields. When a user depresses an individual key of a keypad 13, thereby creating a keypress event, information regarding the keypress event or series of keypress events are communicated from the keypad 13 to the hardware interface layer 50 and then to the keypad interface layer 55 where a signal identifying the specific key or keys pressed is generated. The generated signal is communicated to an application 60 which may re-define the keypress event by implementing a selected data entry method depending on both the application that is running and the specific text field for which the data is being entered.

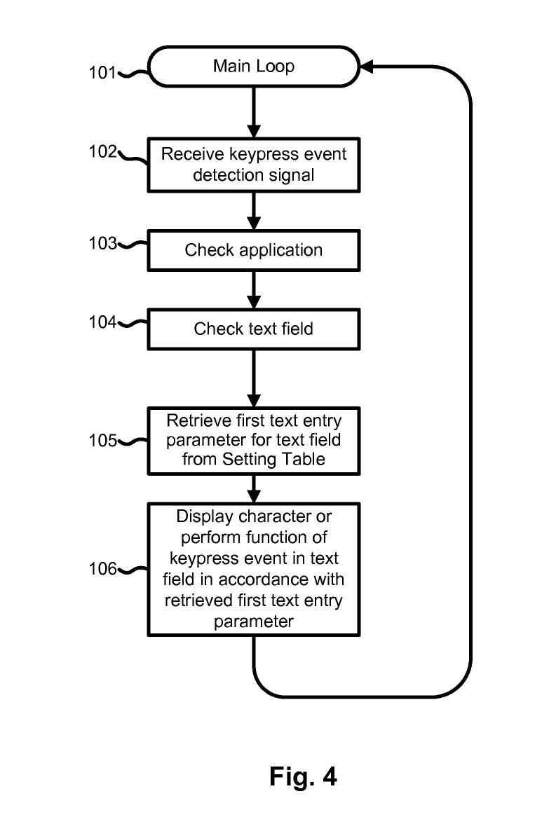

FIG. 4 is a process flow illustrating example steps of an embodiment method. The embodiment method may be implemented within the keypad interface layer 55 or within an application 60. As the main loop is running on a processor, step 101, an indication of a keypress event (e.g., an interrupt signal or an event flag set in memory) is received, step 102. The indication of a keypress event may be a coded signal received by the keypad interface layer 55 from the hardware driver layer 50 or the signal received by the application 60. Once the indication of a keypress event is received, a check may be made to determine the specific application is currently running on the mobile device processor, step 103. A check may also be made to determine the specific text field addressed by the keypress event, step 104. This step is optional since it may not be checked in all embodiments, and may not be required in implementations where the process is accomplished in the application. Once the specific text field is determined, the first data entry parameter for that particular text field is retrieved from memory, such as from a settings table stored in memory, step 105. Thus, if the user has previously customized the mobile device 10 to utilize a particular data entry method as a first data entry parameter for a particular text field, that data entry method will be implemented to assign a value (e.g., a number, letter or punctuation character) to the keypress event (or sequence of keypress events, as when multi-tap is the selected data entry method). In contrast to conventional keypad and user interfaces, the instant embodiment may implement a different data entry method for each text field. Once the customized data entry method is retrieved from the settings table, step 105, the retrieved data entry method is implemented to determine the value to assign to the keypress event and display the corresponding character in the selected text field, step 106. Thus, a user may enter data into a particular field using any of a variety of data entry methods (e.g., multi-tap, predictive text, numeric, etc) which may be preselected and changed from text field to text field.

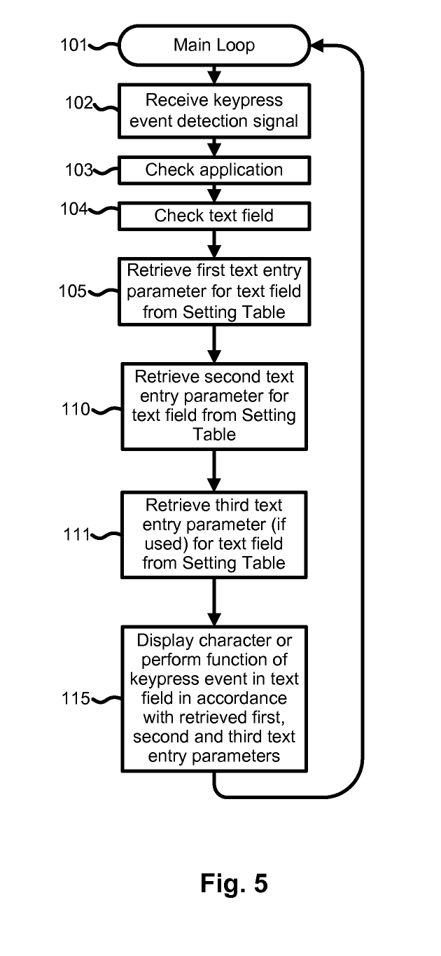

In an embodiment, the user may further customize the selected text field to specify a second and (optionally) third data entry parameters. For example, the user may further customize the selected text field to use a specific text case (i.e., upper or lower case) each time data is entered into the selected individual text field. As another example, the user may further customize the selected text field to use a specific character set or language. FIG. 5 is a process flow diagram illustrating example steps that may performed in this embodiment. In this embodiment, steps 101-105 are performed as described above with respect to FIG. 4. In addition, the customized second data entry parameter for that particular text field is retrieved from a settings table stored in memory, step 110. In the instant example the text entry case may be specified as the second data entry parameter. Thus, data entered in the selected text field will automatically be entered using the customized data entry method (e.g., multi-tap vs. predictive) and in the customized text case (e.g., upper, lower, first character upper). In contrast to conventional keypad and user interfaces (55, 70), this embodiment may implement a different text case for each text field. Optionally, a customized third data entry parameter for that particular text field is retrieved from a settings table stored in memory, step 111. For example, the third data entry parameter may be used to specify a particular character set or language to be used for the selected text field. Alternatively, the second data entry parameter may specify the character set or language to be used for the selected text field while the third data entry parameter specifies the customized text case. Once the second and (optionally) the third text entry parameters are retrieved from the settings table, steps 110, 111, the retrieved first text entry parameter (e.g., data entry method), second text entry parameter (e.g., text case) and third text entry parameter (e.g., character set if used) are implemented to assign a value and display the character corresponding to the keypress event (or series of events) in the selected text field, step 115. Thus, a user may enter data into a particular field using any of a variety of data entry methods (e.g., multi-tap, predictive text, numeric, etc) as well as specify the text character set and case which may change from text field to text field.

As described above, the data entry of individual text fields may be customized to support specific language formats. A user may, for example, wish to customize a particular text field so that any text entered will be in a specific language. By selecting a specific language for a text field the dictionary used for predictive text entry will change. Additionally, variations or special characters exist in many languages that utilize the Roman alphabet. These additional or special characters may be implemented when a user elects to use either predictive text or multi-tap data entry methods. For example, some languages utilize diacritics (sometimes referred to as an accent). A diacritic is a small symbol which can appear above or below a letter or in some other position. As an example, in German the umlaut sign is used in the German characters Ä, Ë, and Ö to indicate a change in the pronounced sound of the written word. Similarly, the Spanish language makes use of the tilde sign (for example the ñ in the word año) to indicate a changed pronunciation. Other examples of languages which use accent symbols include, but are not limited to French, Swedish, Brazilian Portuguese. Still other languages employ digraphs or trigraphs. A digraph is a pair of letters used to write one sound or a combination of sounds that does not correspond to the written letters in sequence. Examples are CH, RH, SH in English, or the Dutch IJ (note that ij is capitalized as IJ, never Ij). A trigraph is made up of three letters, like the German SCH. In the orthographies (writing systems) of some languages, digraphs and trigraphs are regarded as independent letters of the alphabet in their own right. For these languages it would be important to include these independent letters as possible independent entries when using the multi-tap data entry method.

The selected language or character set may be identified in any one of the first, second or third data entry parameters. For example, in discussion above related to FIG. 5, the language or character set was discussed as being either the second or third data entry parameter. In some implementations it may be beneficial to use the first data entry parameter as that selection may impact the options available for the other two data entry parameters. For example, once the specific language is selected as the first data entry parameter, a user may select either predictive text or multi-tap as a second data entry parameter for the selected text field. If the user selects predictive text as the second data entry parameter, the dictionary of possible words that can be predicted will be changed in accordance with the language selected as the first data entry parameter. If the user selects multi-tap as the second data entry parameter, the set of symbols associated to each key of the keypad may be altered so that the additional or variant symbols may be mapped to the keys in the keypad.

It should be noted that a conventional 12-key keypad can support the entry of text that does not employ the Roman alphabet. For example, non-Romanic languages such as Chinese, Japanese, Korean, Hebrew, Arabic, Farsi, Hindi, etc. utilize symbolic characters other than the Roman alphabet. Languages such as Greek and Cyrillic utilize a number of symbols similar to certain Roman alphabet letters as well as symbols unique to their respective languages. Nevertheless, these languages may be specified as a data entry parameter for a selected text field.

To illustrate how non-Roman alphabet languages might enter text data into a text field using a 12-key keypad, a short discussion regarding Chinese text entry follows as an example. The Chinese language utilizes a number of symbolic characters known as hanzi. Since the Chinese language uses a logographic script—that is, a script where one or two “characters” corresponds roughly to one “word” or meaning—there are vastly more characters, or glyphs, than there are keys on a standard computer keyboard. Many early Chinese computers used keyboards with thousands of keys. Given the number of possible characters, text entry on a restrictive 12-key keyboard is challenging.

One method for using a 12-key keyboard to enter Chinese character text is to form a character by individual brush strokes making up the character. Much like a word in a Roman alphabet-based language is formed by linking individual letters, Chinese characters (also referred to as hanzi) are formed by linking a number of elementary stroke movements. These elementary stroke elements may be depicted on a conventional 12-key keypad. A number of methods currently exist which allow users to input Chinese text characters using a conventional 12-key keypad. For example, the CKC Chinese Input System uses a maximum of 4 digits (“0”-“9”) to represent a Chinese character. All possible shapes of strokes that form any given Chinese character are classified into 10 groups, each represented by one of the ten possible digits 0-9. Chinese characters can then be input by following the order in which the strokes are identified at the 4 corners of the character. As a result of this simplicity in coding using the ten numeric digits, users typically need to use only a numeric keypad to input Chinese text.

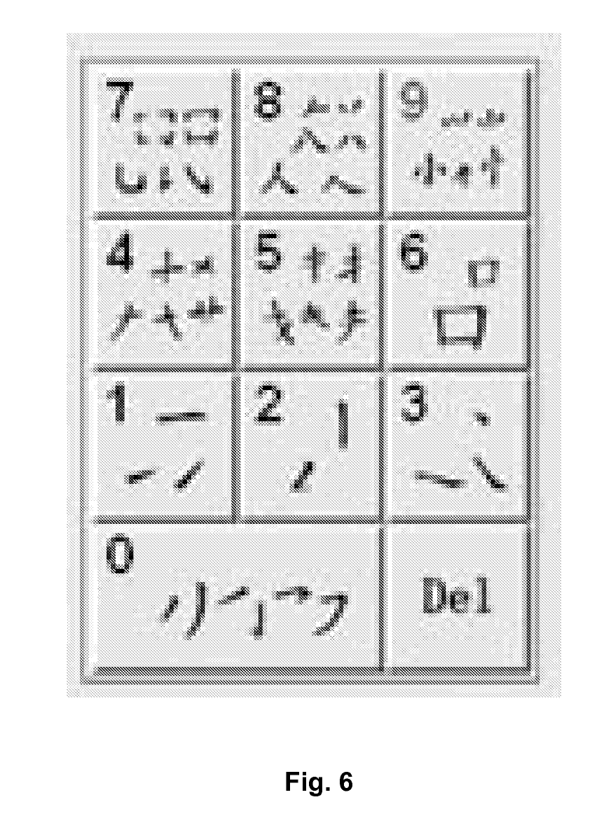

FIG. 6 illustrates an exemplary numeric keypad used in a CKC Chinese Input System. In a CKC Chinese Input System, the mapping between groups of strokes and their corresponding digits 0-9 can be described by the following: the “1” key represents a horizontal stroke; the “2” key a vertical or diagonal stroke; the “3” key represents a dot or left-to-right diagonal stroke; the “4” key represents two strokes in a cross shape; the “5” key represents three or more strokes in which one stroke intersects all others; the “6” key represents a box-shape; the “7” key represents a stroke that turns a corner; the “8” key represents the shape of the Chinese character [symbol] and its inverted form; the “9” key represents the shape of the Chinese character [symbol] and its inverted form; and the “0” key represents a right-to-left diagonal or left hook stroke.

To form a single Chinese character using the CKC Chinese Input System a user breaks down each character into four basic strokes starting with the upper left hand corner of the character as the first code. Second, the user interprets the stroke movement of the upper right hand corner of the character as the second code. Third, the user interprets the stroke movement of the lower left hand corner of the character as the third code. Fourth, the user interprets the stroke movement of the lower right hand corner of the character as the fourth code.

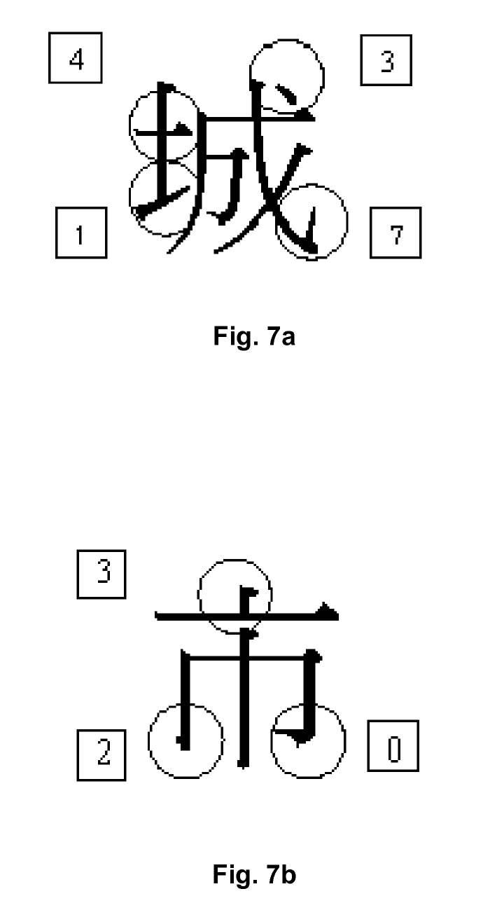

FIG. 7a illustrates an example of the CKC Chinese Input system in use. FIG. 7a depicts the Chinese character “cheng” meaning “city wall.” Looking first to the circled upper left hand corner of the character, two strokes in a cross shape are depicted. The two strokes in a cross shape correspond to the stroke movement shown on the “4” key. Second, looking to the circled upper right hand corner of the character, a left-to-right diagonal stroke is depicted. The left-to-right diagonal stroke corresponds to the stroke movement shown on the “3” key. Third, looking to the circled lower left hand corner of the character, a horizontal stroke is depicted. The horizontal stroke corresponds to the stroke movement shown on the “1” key. Fourth, looking to the circled lower right hand corner of the character, a stroke that turns a corner is depicted. The stroke that turns a corner corresponds to the stroke movement shown on the “7” key. Thus, the CKC Chinese Input system code for the Chinese character representing the word “city wall” is “4317.” In some instances, a Chinese character may be represented with fewer than four stroke movements. In such instances the CKC Chinese Input system code will have fewer than four digits.

For example, in FIG. 7b, the Chinese character “shi” meaning “town” or “city” is depicted. Looking first to the circled upper left hand corner of the character, a dot is depicted. The dot shape corresponds to the stroke movement shown on the “3” key. Second, looking to the circled upper right hand corner of the character, no stroke is depicted. Consequently, no code is needed to represent the second stroke movement. Third, looking to the circled lower left hand corner of the character, a vertical stroke is depicted. The vertical stroke corresponds to the stroke movement shown on the “2” key. Fourth, looking to the circled lower right hand corner of the character, a left hook is depicted. The left hook stroke corresponds to the stroke movement shown on the “0” key. Thus, the CKC Chinese Input system code for the Chinese character representing the word “town” or “city” is “320.”

Alternatively, Chinese characters may be entered into a text field by first entering a phonetic spelling of the Chinese word using the 12-key keypad with Roman alphabet imprinted. Pinyin is the Romanization process in which Chinese words may be phonetically represented using the Roman alphabet. While certain Roman alphabet letter combination may be used to produce sounds in Pinyin that are unlike the same letter combination sounds in other languages, a standard phonetic spelling of each Chinese character has been established. In addition, the Chinese language contains a number of homophones (similarly sounding words with distinct meanings). Such words are distinguished from one another through their tonal pronunciation. For example, the Pinyin word “ma” may mean “mother”, “hemp”, “horse”, “admonish” and a question particle depending on the tonal pronunciation of “ma.” In order to distinguish such words, in the written form, a number following the Pinyin spelling may be used to indicate the correct tonal pronunciation. For example, “ma1” may represent “horse, while “ma3” may represent “mother.”

In operation on a mobile device, the user may enter the Pinyin spelling using the 12-key keypad. The Roman alphabet letters would appear on the user interface screen just as if the user were intending to enter in a word in English. Once the Pinyin spelling is complete, the appropriate Chinese character is displayed on the user interface display. In such applications, the Pinyin spelling may be used to look up a graphic file containing the corresponding hanzi character. Alternatively, as the user enters the Pinyin spelling into the mobile device, the mobile device may display a list of possible Chinese characters corresponding to the entered Pinyin spelling to the user. The user may then use a multi-directional selection keypad to select the desired Chinese character for entry into the text field.

Thus, a Chinese character may be entered into a text field through either a stroke method or a Pinyin method. In each case, the text enter may be further refined to use either a predictive text or a multi-tap method of data entry. For example, a user may elect to manually multi-tap all 1-4 digits of a stroke method code much like a user using multi-tap would manually depress the keys of a keypad until the entire desired word was displayed. Alternatively, a user may use the stroke method coupled with predictive text entry method. As with the predictive text entry method discussed above, as the user enters digits to the stroke method code, the predictive text application may present to the user all of the possible Chinese characters that could be formed before entering the complete stroke method code. The predicted Chinese characters could be displayed to the user on the user interface display and selected by the user using a multi-directional selector switch.

Similarly, a user may elect to enter in the complete Pinyin spelling of a Chinese character using the multi-tap method as described above. Once the user has finished entering the Pinyin word, the corresponding Chinese character may be displayed on the user interface screen. Alternatively, a user may use the Pinyin method coupled with the predictive text entry method. As with the predictive text entry method described above, as the user enters alphabetic letters making up the spelling of the Pinyin word, possible words based upon the text data entry so far may be displayed to the user. The possible words may be either possible Pinyin words or possible Chinese characters. In either case, the predicted Pinyin words or Chinese characters could be displayed to the user on the user interface display and selected by the user using a multi-directional selector switch.

By selecting Chinese as a first data entry parameter, the mobile device processor may retrieve the appropriate dictionaries and symbols to be displayed in either a predictive or multi-tap method. By selecting either the stroke method or Pinyin method as a second data entry parameter, the mobile device processor may retrieve the appropriate application to permit the display of Chinese characters. By selecting either predictive text or multi-tap method as a third data entry parameter, the mobile device processor may retrieve the appropriate application to enable either predictive text or multi-tap method data entry. In such an embodiment, the mobile device processor would allow the user to customize not only the data entry method for a selected text field, but also the language for all text entered in the selected text field. One of skill in the art would appreciate that other non-Roman alphabet languages may be selected as the first data entry parameter to enable the entry of text in a text field in any language. The discussion of the Chinese text entry is meant to be illustrative only.

Further embodiments enable additional customization of data entry methods on a text field basis. For example, in addition to customizing the data entry method and text case of entries in a specific text field, the user may further customize the text entry method to set the font of the text to be entered in the selected text field so that any text entered in the selected text field will be entered using a customized data entry method with a customized text case and a customized text font. Other parameters of the text that may be customized may include the size of text, color of text, highlighting, alignment, etc. In other embodiments, various combinations of parameters may be customized and stored in a settings table such that each text field has a variety of data entry parameters that may be customized to a user's specifications.

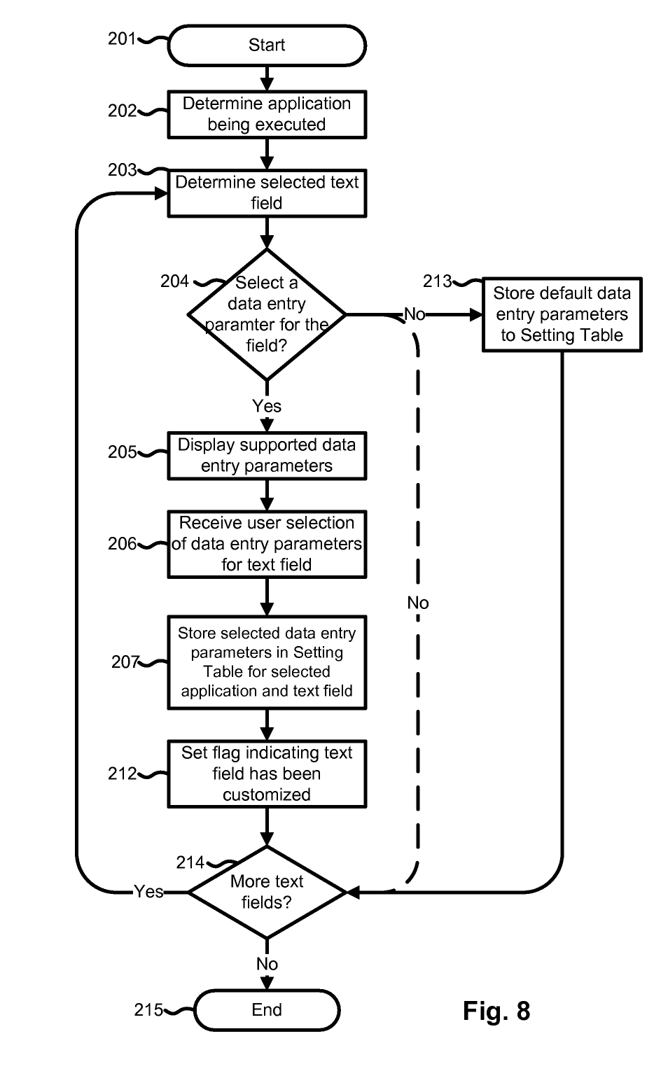

FIG. 8 is a process flow diagram illustrating example steps that may be performed during a customization routine which allows a user to select a specific data entry parameter for each text field in a particular application. A customization routine may be started at any time. For example, a user may wish to start the customization routine, step 201, customize the text fields of an application running on the mobile device 10 when the user loads a new application, after the application has been loaded, or when the application is executing. The customization routine may determine which application is being executed and what text field is selected, steps 202 and 203. Determining a selected text field may be accomplished by receiving a signal from the keyboard interface 55 or application 60 indicating the particular text field associated with the position of the cursor appearing on the device display. The customization routine may inquire (by way of a prompt presented on the device display) whether the user wishes to select a data entry parameter for the selected text field, test 204. In the case where the customization routine is initiated when a new application is being loaded, the user may elect to use the default settings associated with a text field. If the user's response to this prompt is negative (e.g., indicated by a press of the 6 key) (i.e., test 204=“No”), the default data entry parameters may be stored in a setting table for the selected application and text field, step 213. Once the default data entry parameters have been stored, the customization routine may determine if there are further text fields remain to be customized, test 214, and if so, advance the cursor and return to determining the selected text field, step 203. If there are no further text fields to be customized (i.e., test 214=“No”), then the routine may end with processing returned to the main loop, step 215.

If the user does wish to customize the data entry parameters for the selected application and text field (i.e., test 204=“Yes”), the customization routine may present on the interface display a summary of available data entry parameters from which the user can choose, step 205. The customization routine can receive the user selected data entry parameters to implement for data entries in the selected text field, step 206. The customization routine then stores the selected data entry parameters for the selected application and text field such as in a settings table, step 207. Once the selected data entry method has been stored, a flag indicating that the selected text field has been customized may be set (such as by storing a “1” in a particular memory register), step 212. Once the flag is set the customization routine may determine if there are further text fields remain to be customized, test 214, and if so, advance the cursor and return to determining the selected text field, step 203. If there are no further text fields to be customized (i.e., test 214=“No”), then the routine may end with processing returned to the main loop, step 215.

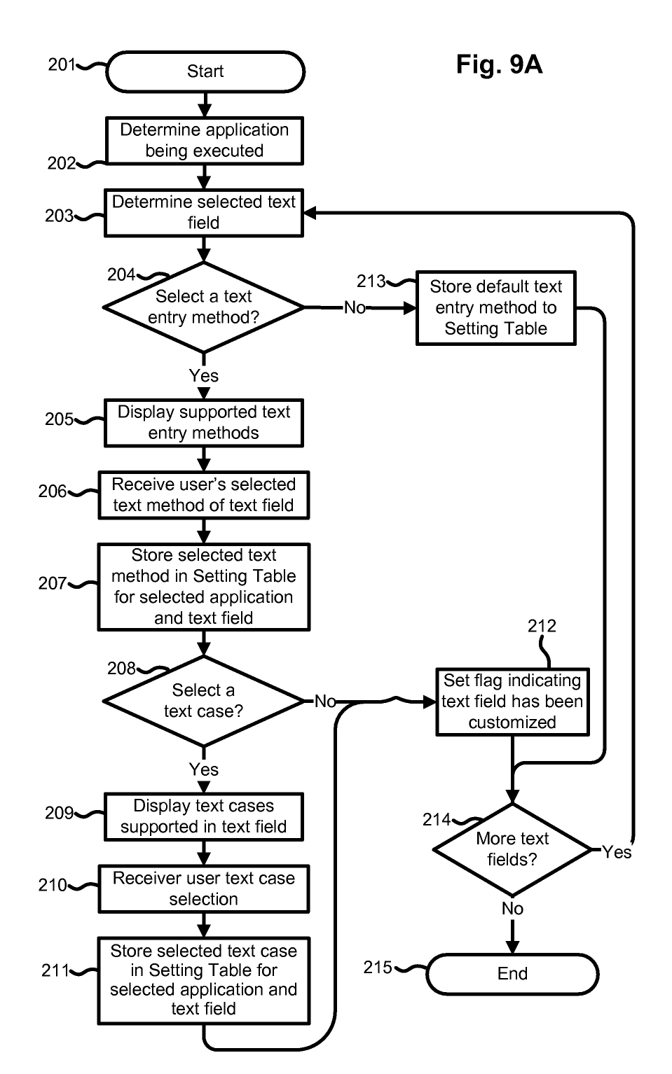

FIG. 9A is a process flow diagram illustrating example steps performed in an alternative customization routine embodiment which allows a user to select a first data entry parameter as well as a second data entry parameter for each text field. In the illustrative example shown in FIG. 9A, the first data entry parameter is a data entry method (i.e., predictive vs. multi-tap) and the second data entry parameter is the text case (i.e., upper vs. lower case). The alternative embodiment illustrated in FIG. 9A includes steps 201-207 as described above with reference to FIG. 8. In addition, after storing the data entry method in a setting table for the selected application and text field, the customization routine inquires (by way of a prompt presented on the device display) whether the user would like to customize the text case (e.g., uppercase, lowercase, or first character upper only, etc) for the selected text field, test 208. In the case where the customization routine is initiated when a new application is being loaded, the user may elect to use the default settings associated with a text field. If the user's response to this prompt is negative (e.g., indicated by a press of the 6 key) (i.e., test 208=“No”), the customization routine sets a flag indicating that the selected text field has been customized (such as by storing a “1” in a particular memory register) since at least the text data entry method has been customized, step 213. Once the flag has been set, the customization routine may determine if there are further text fields remain to be customized, test 214, and if so, advance the cursor and return to determining the selected text field, step 203. If there are no further text fields to be customized (i.e., test 214=“No”), then the routine may end with processing returned to the main loop, step 215.

If the user does wish to customize the text case for the selected application and text field (i.e., test 208=“Yes”), the customization routine may present on the interface display 11 a summary of available text cases supported in the text field from which the user can choose, step 209. The customization routine can receive the user selected text case to implement for data entries in the selected text field, step 210. The customization routine then stores the selected text case for the selected application and text field such as in the settings table, step 211. Once the selected data entry method has been stored, a flag may be set indicating that the selected text field has been customized is set (such as by storing a “1” in a particular memory register), step 212. Once the flag is set the customization routine may determine if there are further text fields remain to be customized, test 214, and if so, advance the cursor and return to determining the selected text field, step 203. If there are no further text fields to be customized (i.e., test 214=“No”), then the routine may end with processing returned to the main loop, step 215.

Further embodiments enable additional customization of data entry methods on a text field basis. For example, in addition to customizing the data entry method and text case of entries in a specific text field, the user may further customize the text entry method to set the font of the text to be entered in the selected text field so that any text entered in the selected text field will be entered using a customized data entry method with a customized text case, and a customized text font. In other embodiments, various combinations of parameters may be customized and stored in a settings table such that each text field has a variety of data entry parameters that may be customized to a user's specifications. Alternative customization setup routines may be used that include additional steps to enable users to customize such additional data entry parameters.

FIG. 9B is a process flow diagram illustrating example steps performed in an alternative customization routine embodiment which allows a user to select a first, second and third data entry parameter for each text field. As discussed above, the first data entry parameter could be a language or character set selection. The alternative embodiment illustrated in FIG. 9B includes steps 201-203 as described above with reference to FIG. 8. The customization routine may inquire (by way of a prompt presented on the device display) whether the user wishes to select a first data entry parameter for the selected text field, test 304. In the case where the customization routine is initiated when a new application is being loaded, the user may elect to use the default settings associated with a text field. If the user's response to this prompt is negative (e.g., indicated by a press of the 6 key) (i.e., test 304=“No”), the default data entry parameters may be stored in a setting table for the selected application and text field, step 313. Once the default data entry parameters have been stored, the customization routine may determine if there are further text fields remain to be customized, test 314, and if so, advance the cursor and return to determining the selected text field, step 203. If there are no further text fields to be customized (i.e., test 314=“No”), then the routine may end with processing returned to the main loop, step 315.

If the user does wish to customize the data entry parameters for the selected application and text field (i.e., test 304=“Yes”), the customization routine may present on the interface display a summary of available data entry parameters from which the user can choose, step 305. The customization routine can receive the user selected data entry parameters to implement for data entries in the selected text field, step 306. The customization routine then stores the selected data entry parameters for the selected application and text field such as in a settings table, step 307. The customization routine then may inquire whether the user wishes to customize a another (second, third, fourth, etc.) data entry parameter, test 308. If so, the process repeats steps 305-307 of obtaining and storing the user's data entry parameter selections. Once the selected data entry parameters has been stored and the user indicates no further parameters are to be customized (or there are no more parameters to be customized), a flag indicating that the selected text field has been customized may be set (such as by storing a “1” in a particular memory register), step 312. Once the flag is set the customization routine may determine if there are further text fields remain to be customized, test 314, and if so, advance the cursor and return to determining the selected text field, step 203. If there are no further text fields to be customized (i.e., test 314=“No”), then the routine may end with processing returned to the main loop, step 315.

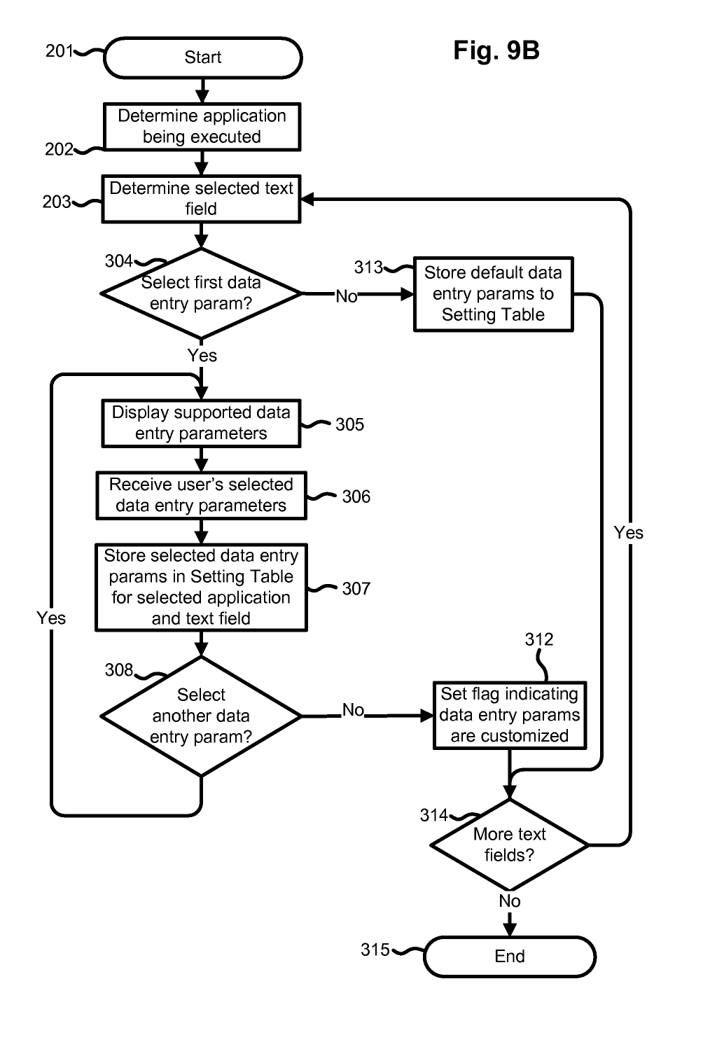

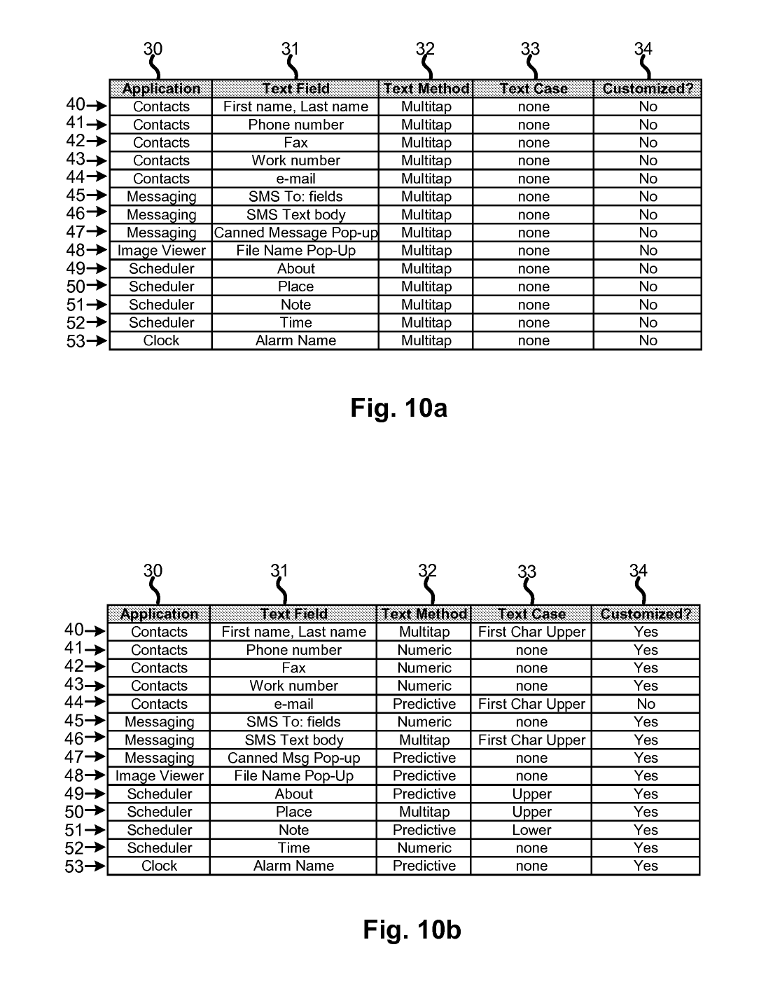

FIG. 10a illustrates an exemplary settings data table for storing various text fields for different applications including default settings for all entries. Such a default table may be initially loaded in memory by the original equipment manufacturer (OEM). As new applications are loaded onto a mobile device the software initialization routine may add a data record to include default parameter settings appropriate for the new application. A setting table may be structured as a plurality of data records (rows 40-53) including a number of data fields (columns 30-34). In this example data structure, each text field (identified in column 31) in each application (identified in column 30) is addressed by a data record 40-53. In the illustrated example, the applications loaded on the mobile device 10 include “contacts,” “Messaging,” “Image Viewer,” “Scheduler,” and “clock.” In the illustrated example, the “contacts” application includes text fields: “First name, Last Name,” “Phone Number,” “Fax,” “Work Number,” and “email.” The text fields within the “messaging” application include: “SMS To: fields,” “SMS Text Body,” and “Canned Msg Pop-Up.” The text fields within the “image viewer” application include “File Name Pop Up.” The text fields within the “scheduler” application include: “About,” “Place,” “Note,” and “Time.” The text fields within the “Clock” application include “Alarm Name.” Since FIG. 8a illustrates to the default settings table, all of the data entry methods values are set to “multitap,” all text cases are set to “none,” and all customized flags are set to “No.”

FIG. 10b illustrates the exemplary settings data table after some data entry method settings have been customized. In the example shown in FIG. 10b, the data entry method has been customized for the “First Name, Last Name” field of the “contacts” application. Specifically, the data entry method remains “multitap,” but the text case selected is “First Character Upper” (abbreviated as “First Char Upper”). To indicate that this text field has been customized, the customized flag is set indicated by the value “yes” (this may be indicated by storing a binary “1” in this data field). As previously discussed, predictive text may be cumbersome to use when entering proper names as most names are not recognized by current predictive text algorithms. In addition, some users may simply prefer the multitap method as the text data entry method for entering names. Thus, in the instant example the user has chosen to use the multitap method. In addition, the user has set the text case for the “First Name, Last Name” text field of the “contacts” application to “First Character Upper.” With these selections, each time the user enters text data in the “First Name, Last Name” text field of the “contacts” application, the data entry method will revert to multitap method and display the first character of word in uppercase.

As a further example, the “phone number” text field of the “contacts” application has been customized to use the “numeric” data entry method. This means that the keypad will revert to a numeric only data entry method whenever the user is entering data in the “phone number” text field of the “contacts” application. Since numeric entries do not require a case, the text case for the “phone number” text field of the “contacts” application is left to the default setting of “none.” To indicate that this text field has been customized, the customized flag is set indicated by the value “yes” In the illustrated example, the “fax,” and “work number” text fields have also been customized to use the numeric data entry method.

As a further example, the text field “email” within the “contacts” application has been customized to use the “Predictive” text data entry method since this method is useful when generating long text messages using words that found in a dictionary. In addition, the customization flag has been set to “First Char Upper” to facilitate sentence capitalization.

As a further example, the “SMS text body” text field under the “messaging” application has been customized to use the “Multitap” data entry method. While a predictive data entry method is most useful when generating long text messages, some users prefer to use short hand text common to instant messaging, particularly when they know the recipient will be reading the message on a small cell phone display. For example, a user may wish to enter “bff” instead of “best friend forever.” With such preferences for text messaging, multitap will be preferred over predictive text data entry methods. Thus, while a “SMS Text Body” text field may be an ideal candidate for a predictive data entry method, the illustrated example shows that a different data entry method has been selected.

It is noted however, that the settings table shown in FIGS. 10a and 10b, including the listed applications and text fields are merely illustrative. A variety of data structures may be used for recording user data entry method selections and settings applications and their respective text entry fields. More or fewer applications and text fields may be stored in the settings table. Also not all text fields must be customized. Individual users many wish to use different methods and cases for different text fields based upon their own comfort level and preference. The figures are merely meant to illustrate a possible configuration and one set of example settings.

The foregoing method descriptions and the process flow diagrams merely as illustrative examples, and are not intended to require or imply that the steps of the various embodiments must be performed in the order presented. As will be appreciated by one of skill in the art the order of steps in the foregoing embodiments may be performed in any order.

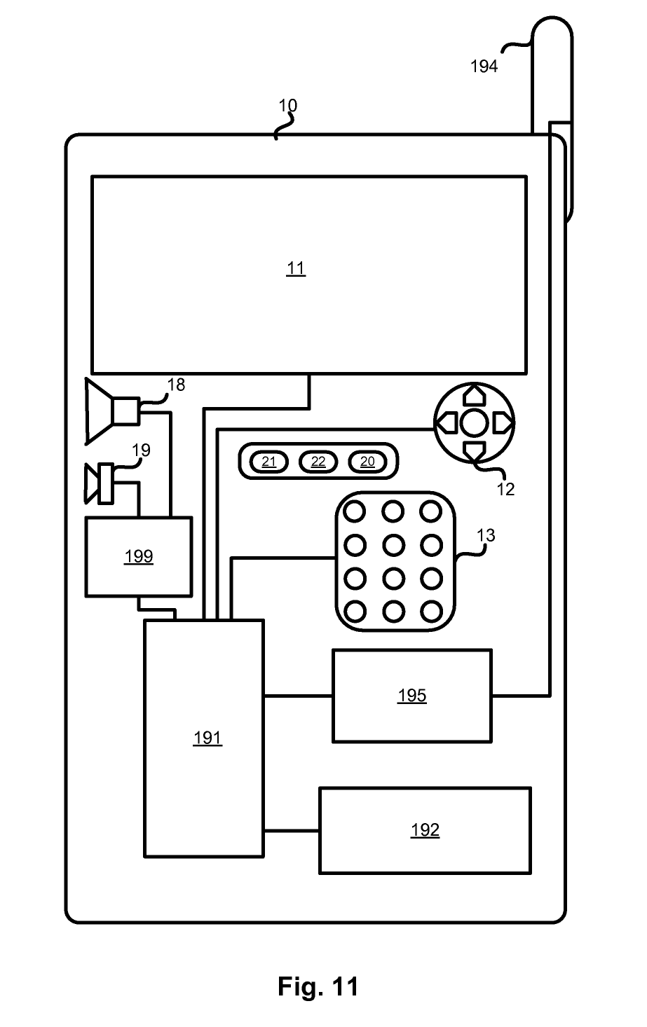

The embodiments described above may be implemented on any of a variety of mobile devices, such as, for example, cellular telephones, personal data assistants (PDA) with cellular telephone, mobile electronic mail receivers, mobile web access devices, and other processor equipped devices that may be developed in the future. In addition, the embodiments described above may be implemented on any of a variety of computing devices, including but not limited to desktop and laptop computers. FIG. 11 depicts various components of a mobile device 10 capable of supporting the various embodiments disclosed herein. A typical mobile handset 10 includes a processor 191 coupled to internal memory 192 and a user interface display 11. The mobile handset 10 may include an antenna 194 for sending and receiving electromagnetic radiation that is connected to a wireless data link and/or cellular telephone transceiver 195 coupled to the processor 191. In some implementations, the transceiver 195, and portions of the processor 191 and memory 192 used for cellular telephone communications are referred to as the air interface since the combination provides a data interface via a wireless data link. Further, the mobile device 10 includes a speaker 18 to produce audible sound and a microphone 19 for sensing sound, such as receiving the speech of a user. Both the microphone 19 and speaker 18 may be connected to the processor 191 via a vocoder 199 which transforms analog electrical signals received from the microphone 19 into digital codes, and transform digital codes received from the processor 191 into analog electrical signals which the speaker 18 can transform into sound waves. In some implementations, the vocoder 199 may be included as part of the circuitry and programming of the processor 191.

The processor 191 may be any programmable microprocessor, microcomputer or multiple processor chip or chips that can be configured by software instructions (applications) to perform a variety of functions, including the functions of the various embodiments described above. In some mobile devices, multiple processors 191 may be provided, such as one processor dedicated to wireless communication functions and one processor dedicated to running other applications. Typically, software applications may be stored in the internal memory 192 before they are accessed and loaded into the processor 191. In some mobile devices, the processor 191 may include internal memory sufficient to store the application software instructions. For the purposes of this description, the term memory refers to all memory accessible by the processor 191, including internal memory 192 and memory within the processor 191 itself. The memory 192 may be volatile or nonvolatile memory, such as flash memory, or a mixture of both. Mobile handsets typically include a key pad 13, as well as other hard keys 14, 15, 16, 17 (not shown) and menu selection buttons or rocker switches 12 for receiving user inputs.

The various embodiments described above may be implemented on a typical mobile device 10 by a user executing a new application via keypad 13 and/or menu selection buttons 12 and an application dispatcher in memory 192 which comprises processor executable software instructions that will cause the processor 191 to execute the embodiment methods described herein to display an animated graphical image on the user interface display 11.

The hardware used to implement the foregoing embodiments may be processing elements and memory elements configured to execute a set of instructions, wherein the set of instructions are for performing method steps corresponding to the above methods. Alternatively, some steps or methods may be performed by circuitry that is specific to a given function.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. The software module may reside in a processor readable storage medium and/or processor readable memory both of which may be any of RAM memory, flash memory, ROM memory, EPROM memory, EEPROM memory, registers, hard disk, a removable disk, a CD-ROM, or any other tangible form of data storage medium known in the art. Moreover, the processor readable memory may comprise more than one memory chip, memory internal to the processor chip, in separate memory chips, and combinations of different types of memory such as flash memory and RAM memory. References herein to the memory of a mobile handset are intended to encompass any one or all memory modules within the mobile handset without limitation to a particular configuration, type or packaging. An exemplary storage medium is coupled to a processor in either the mobile handset or the theme server such that the processor can read information from, and write information to, the storage medium. In the alternative, the storage medium may be integral to the processor. The processor and the storage medium may reside in an ASIC.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

We claim:

1. A method for customizing individual text field characteristics on a mobile device, comprising:
selecting a text field of an application to customize;
prompting a user to select a first data entry parameter for use in entering data into the selected text field of the application;
receiving a first data entry parameter selection from the user;
storing the first data entry parameter selection in memory; and
implementing the stored first data entry parameter selection each time data is entered in the selected text field of the application executing on the mobile device.

2. The method of claim 1, further comprising:
prompting a user to select a second data entry parameter for use in entering data into the selected text field of the application;
receiving a second data entry parameter selection from the user;
storing the second data entry parameter selection in memory; and
implementing the stored selected second data entry parameter selection each time data is entered in the selected text field of the application executing on the mobile device.

3. The method of claim 2, further comprising:
prompting a user to select a third data entry parameter for use in entering data into the selected text field of the application;
receiving a third data entry parameter selection from the user;
storing the third data entry parameter selection in memory; and
implementing the stored selected third data entry parameter selection each time data is entered in the selected text field of the application executing on the mobile device.

4. The method of claim 1, wherein the first data entry parameter is selected from a group comprising a specified language, a character set and a data entry method.

5. The method of claim 2, wherein the second data entry parameter is selected from a group comprising the data entry method, a non-Roman language entry method, a text case and a text font.

6. The method of claim 3, wherein the first data entry parameter is a data entry method selected from a group comprising multi-tap, predictive text, and numeric text data entry methods.

7. The method of claim 2, wherein the second data entry parameter concerns a character formation method

8. The method of claim 7, wherein the character formation method is selected from a group comprising stroke method and Pinyin.

9. A method for customizing individual text field characteristics on a mobile device, comprising:
receiving an interrupt indicating a keypress event;
determining an application currently executing on the mobile device;
determining a text field corresponding to the keypress event;
retrieving a first customized data entry parameter from memory corresponding to the determined text field and application; and
using the retrieved first customized data entry parameter to determine a value to be entered in the text field in response to the keypress event.

10. The method of claim 9 further comprising:
retrieving a second customized data entry parameter from memory corresponding to the determined text field and application; and
using the retrieved second data entry parameter to determine a value to be entered in the text field in response to the keypress event.

11. The method of claim 10 further comprising:
retrieving a third customized data entry parameter from memory corresponding to the determined text field and application; and
using the retrieved third data entry parameter to determine a value to be entered in the text field in response to the keypress event.

12. The method of claim 9, wherein the first data entry parameter is selected from a group comprising a specified language, a character set and a data entry method.

13. The method of claim 11, wherein the second data entry parameter is selected from a group comprising the data entry method, a non-Roman language entry method, a text case and a text font.

14. The method of claim 10, wherein the first data entry parameter is a data entry method selected from a group comprising multi-tap, predictive text, and numeric text data entry methods.

15. The method of claim 10, wherein the second data entry parameter concerns a character formation method

16. The method of claim 15, wherein the character formation method is selected from a group comprising stroke method and Pinyin

17. A mobile device, comprising:
a user interface display;
a user interface keypad;
a processor coupled to the user interface keypad and the user interface display;
a memory coupled to the processor; said memory having stored therein processor executable software instructions configured to cause the processor to perform steps comprising:
selecting a text field of an application to customize;
prompting a user to select a first data entry parameter for use in entering data into the selected text field of the application;
receiving a first data entry parameter selection from the user;
storing the first data entry parameter selection in memory; and
implementing the stored first data entry parameter selection each time data is entered in the selected text field of the application executing on the mobile device.

18. The mobile device of claim 17, wherein the processor executable software instructions stored in the memory are configured to cause the processor to further perform steps comprising:
prompting a user to select a second data entry parameter for use in entering data into the selected text field of the application;
receiving a second data entry parameter selection from the user;
storing the second data entry parameter selection in memory; and
implementing the stored selected second data entry parameter selection each time data is entered in the selected text field of the application executing on the mobile device.

19. The mobile device of claim 18, wherein the processor executable software instructions stored in the memory are configured to cause the processor to further perform steps comprising:
prompting a user to select a third data entry parameter for use in entering data into the selected text field of the application;
receiving a third data entry parameter selection from the user;
storing the third data entry parameter selection in memory; and
implementing the stored selected third data entry parameter selection each time data is entered in the selected text field of the application executing on the mobile device.

20. The mobile device of claim 17, wherein the first data entry parameter is selected from a group comprising a specified language, a character set and a data entry method.

21. The mobile device of claim 18, wherein the second data entry parameter is selected from a group comprising the data entry method, a non-Roman language entry method, a text case and a text font.

22. The mobile device of claim 17, wherein the first data entry parameter is a data entry method selected from a group comprising multi-tap, predictive text, and numeric text data entry methods.

23. The mobile device of claim 18, wherein the second data entry parameter concerns a character formation method.

24. The mobile device of claim 23, wherein the character formation method is selected from a group comprising stroke method and Pinyin

25. A mobile device, comprising:
a user interface display;
a user interface keypad;
a processor coupled to the user interface keypad and the user interface display;
a memory coupled to the processor; said memory having stored therein processor executable software instructions configured to cause the processor to perform steps comprising:
determining an application currently executing on the mobile device;
determining a text field corresponding to the keypress event;
retrieving a first customized data entry parameter from memory corresponding to the determined text field and application; and
using the retrieved first customized data entry parameter to determine a value to be entered in the text field in response to the keypress event.

26. The mobile device of claim 25, wherein the processor executable software instructions stored in the memory are configured to cause the processor to further perform steps comprising:
retrieving a second customized data entry parameter from memory corresponding to the determined text field and application; and
using the retrieved second data entry parameter to determine a value to be entered in the text field in response to the keypress event.

27. The mobile device of claim 26, wherein the processor executable software instructions stored in the memory are configured to cause the processor to further perform steps comprising:
retrieving a third customized data entry parameter from memory corresponding to the determined text field and application; and
using the retrieved third data entry parameter to determine a value to be entered in the text field in response to the keypress event.

28. The mobile device of claim 25, wherein the first data entry parameter is selected from a group comprising a specified language, a character set and a data entry method.

29. The mobile device of claim 26, wherein the second data entry parameter is selected from a group comprising the data entry method, a non-Roman language entry method, a text case and a text font.

30. The mobile device of claim 25, wherein the first data entry parameter is a data entry method selected from a group comprising multi-tap, predictive text, and numeric text data entry methods.

31. The mobile device of claim 26, wherein the second data entry parameter concerns a character formation method.

32. The mobile device of claim 31, wherein the character formation method is selected from a group comprising stroke method and Pinyin

33. A mobile device, comprising:
means for selecting a text field of an application to customize;
means for prompting a user to select a first data entry parameter for use in entering data into the selected text field of the application;
means for receiving a first data entry parameter selection from the user;
means for storing the first data entry parameter selection in memory; and
means for implementing the stored first data entry parameter selection each time data is entered in the selected text field of the application executing on the mobile device.

34. The mobile device of claim 33, further comprising:
means for prompting a user to select a second data entry parameter for use in entering data into the selected text field of the application;
means for receiving a second data entry parameter selection from the user;
means for storing the second data entry parameter selection in memory; and
means for implementing the stored selected second data entry parameter selection each time data is entered in the selected text field of the application executing on the mobile device.

35. The mobile device of claim 34, further comprising:
means for prompting a user to select a third data entry parameter for use in entering data into the selected text field of the application;
means for receiving a third data entry parameter selection from the user;
means for storing the third data entry parameter selection in memory; and
means for implementing the stored third second data entry parameter selection each time data is entered in the selected text field of the application executing on the mobile device.

36. The mobile device of claim 33, wherein the first data entry parameter is selected from a group comprising a specified language, a character set and a data entry method.

37. The mobile device of claim 34, wherein the second customized data entry parameter is selected from a group comprising the data entry method, a non-Roman language entry method, a text case and a text font.

38. The mobile device of claim 33, wherein the first data entry parameter is a data entry method selected from a group comprising multi-tap, predictive text, and numeric text data entry methods.

39. The mobile device of claim 34, wherein the second data entry parameter concerns a character formation method.

40. The mobile device of claim 39, wherein the character formation method is selected from a group comprising stroke method and Pinyin

41. A mobile device, comprising:
means for receiving an interrupt indicating a keypress event;
means for determining an application currently executing on the mobile device;
means for determining a text field corresponding to the keypress event;
means for retrieving a first customized data entry parameter from memory corresponding to the determined text field and application; and
means for using the retrieved first customized data entry parameter to determine a value to be entered in the text field in response to the keypress event.

42. The mobile device of claim 41, further comprising:
means for retrieving a second customized data entry parameter from memory corresponding to the determined text field and application; and
means for using the retrieved second data entry parameter to determine a value to be entered in the text field in response to the keypress event.

43. The mobile device of claim 42, further comprising:
means for retrieving a second customized data entry parameter from memory corresponding to the determined text field and application; and
means for using the retrieved second data entry parameter to determine a value to be entered in the text field in response to the keypress event.

44. The mobile device of claim 41, wherein the first data entry parameter is selected from a group comprising a specified language, a character set and a data entry method.

45. The mobile device of claim 42, wherein the second customized data entry parameter is selected from a group comprising the data entry method, a non-Roman language entry method, a text case and a text font.

46. The mobile device of claim 41, wherein the first data entry parameter is a data entry method selected from a group comprising multi-tap, predictive text, and numeric text data entry methods.

47. The mobile device of claim 42, wherein the second data entry parameter concerns a character formation method.

48. The mobile device of claim 47, wherein the character formation method is selected from a group comprising stroke method and Pinyin.

49. A tangible processor-readable storage medium having stored thereon processor-executable software instructions configured to cause a processor to perform steps comprising:
selecting a text field of an application to customize;
prompting a user to select a first data entry parameter for use in entering data into the selected text field of the application;
receiving a first data entry parameter selection from the user;
storing the first data entry parameter selection in memory; and
implementing the stored first data entry parameter selection each time data is entered in the selected text field of the application executing on the mobile device.

50. The tangible processor-readable storage medium of claim 49 further having stored thereon processor-executable software instructions configured to cause a processor to perform the further steps of:
prompting a user to select a second data entry parameter for use in entering data into the selected text field of the application;
receiving a second data entry parameter selection from the user;
storing the second data entry parameter selection in memory; and
implementing the stored selected second data entry parameter selection each time data is entered in the selected text field of the application executing on the mobile device.

51. The tangible processor-readable storage medium of claim 50 further having stored thereon processor-executable software instructions configured to cause a processor to perform the further steps of:
prompting a user to select a third data entry parameter for use in entering data into the selected text field of the application;
receiving a third data entry parameter selection from the user;
storing the third data entry parameter selection in memory; and
implementing the stored selected third data entry parameter selection each time data is entered in the selected text field of the application executing on the mobile device.

52. The tangible processor-readable storage medium of claim 49, wherein the first data entry parameter is selected from a group comprising a specified language, a character set and a data entry method.

53. The tangible processor-readable storage medium of claim 50, wherein the second customized data entry parameter is selected from a group comprising the data entry method, a non-Roman language entry method, a text case and a text font.

54. The tangible processor-readable storage medium of claim 49, wherein the first data entry parameter is a data entry method selected from a group comprising multi-tap, predictive text, and numeric text data entry methods.

55. The tangible processor-readable storage medium of claim 50, wherein the second data entry parameter concerns a character formation method.

56. The tangible processor-readable storage medium of claim 55, wherein the character formation method is selected from a group comprising stroke method and Pinyin.

57. A tangible processor-readable storage medium having stored thereon processor-executable software instructions configured to cause a processor to perform steps comprising:
receiving an interrupt indicating a keypress event;
determining an application currently executing on the mobile device;
determining a text field corresponding to the keypress event;
retrieving a first customized data entry parameter from memory corresponding to the determined text field and application; and
using the retrieved first customized data entry parameter to determine a value to be entered in the text field in response to the keypress event.

58. The tangible processor-readable storage medium of claim 57 further having stored thereon processor-executable software instructions configured to cause a processor to perform the further steps of:
retrieving a second customized data entry parameter from memory corresponding to the determined text field and application; and
using the retrieved second data entry parameter to determine a value to be entered in the text field in response to the keypress event.

59. The tangible processor-readable storage medium of claim 58 further having stored thereon processor-executable software instructions configured to cause a processor to perform the further steps of:
retrieving a third customized data entry parameter from memory corresponding to the determined text field and application; and
using the retrieved third data entry parameter to determine a value to be entered in the text field in response to the keypress event.

60. The tangible processor-readable storage medium of claim 57, wherein the first data entry parameter is selected from a group comprising a specified language, a character set and a data entry method.

61. The tangible processor-readable storage medium of claim 58, wherein the second customized data entry parameter is selected from a group comprising the data entry method, a non-Roman language entry method, a text case and a text font.

62. The tangible processor-readable storage medium of claim 57, wherein the first data entry parameter is a data entry method selected from a group comprising multi-tap, predictive text, and numeric text data entry methods.

63. The tangible processor-readable storage medium of claim 58, wherein the second data entry parameter concerns a character formation method.

64. The tangible processor-readable storage medium of claim 63, wherein the character formation method is selected from a group comprising stroke method and Pinyin.
